(19) United States
(12) Patent Application Publication
(10) Pub. No.: US 2024/0280369 A1
(43) Pub. Date: Aug. 22, 2024

(54) INFORMATION PROCESSING DEVICE AND INFORMATION PROCESSING METHOD

(71) Applicant: Toyota Jidosha Kabushiki Kaisha, Toyota-shi (JP)

(72) Inventor: Toshihiko INOUE, Nagoya-shi (JP)

(73) Assignee: Toyota Jidosha Kabushiki Kaisha, Toyota-shi (JP)

(21) Appl. No.: 18/526,122

(22) Filed: Dec. 1, 2023

(30) Foreign Application Priority Data
Feb. 22, 2023 (JP) 2023-025784

(51) Int. Cl. G01C 21/34; G01C 21/36

(52) U.S. Cl. CPC G01C 21/3492; G01C 21/3617; G01C 21/3679

(57) ABSTRACT

An information processing device provides information to an occupant of a vehicle that is traveling. The information processing device includes a control unit configured to: acquire destination congestion information, the destination congestion information being information on a destination congestion degree indicating a degree of congestion of a destination of the vehicle, and determine whether to output information on a first rest facility based on the destination congestion information, the first rest facility being a rest facility that is present between a traveling location of the vehicle and the destination.

### CROSS-REFERENCE TO RELATED APPLICATION

This application claims priority to Japanese Patent Application No. 2023-025784 filed on Feb. 22, 2023, incorporated herein by reference in its entirety.

### BACKGROUND

### 1. Technical Field

The present disclosure relates to devices for providing information to a vehicle occupant.

### 2. Description of Related Art

A number of techniques for providing information to a vehicle occupant are known in the art. For example, Japanese Unexamined Patent Application Publication No. 2019-158594 (JP 2019-158594 A) discloses a device configured to generate congestion information on each stop-off facility according to the distance from the traveling location to the stop-off facility and output the generated congestion information to a vehicle occupant.

### SUMMARY

It is an object of the present disclosure to make a suggestion about a break to a driver of a vehicle according to how congested a destination is.

One aspect of an embodiment of the present disclosure is an information processing device configured to provide information to an occupant of a vehicle that is traveling.

The information processing device includes a control unit configured to acquire destination congestion information, the destination congestion information being information on a destination congestion degree indicating a degree of congestion of a destination of the vehicle, and
determine whether to output information on a first rest facility based on the destination congestion information, the first rest facility being a rest facility that is present between a traveling location of the vehicle and the destination.

Another aspect of an embodiment of the present disclosure is
an information processing method that is performed by an information processing device configured to provide information to an occupant of a vehicle that is traveling.
   The information processing device includes:
acquiring destination congestion information, the destination congestion information being information on a destination congestion degree indicating a degree of congestion of a destination of the vehicle; and
determining whether to output information on a first rest facility based on the destination congestion information, the first rest facility being a rest facility that is present between a traveling location of the vehicle and the destination.

Other aspects include a method that is performed by the above device, a program for causing a computer to perform the method, and a computer-readable storage medium storing the program in a non-transitory manner.

According to the present disclosure, it is possible to make a suggestion about a break to a driver of a vehicle according to how congested a destination is.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram for explaining the concept of a service provided by information processing devices according to first to third embodiments;

FIG. 2 is a diagram for explaining components of the information processing device according to the first embodiment;

FIG. 3 is a flowchart of processing executed by a control unit of the information processing device according to the first embodiment;

FIG. 4 is a diagram for explaining constituent elements of the information processing device according to the third embodiment;

FIG. 5 is a flowchart of processing executed by the control unit of the information processing device according to the third embodiment; and

FIG. 6 is a flowchart of processing executed by a control unit of an information processing device according to a modification of the third embodiment.

### DETAILED DESCRIPTION OF EMBODIMENTS

There is known a device for providing information on facilities on a planned route of a vehicle to an occupant of the vehicle while the vehicle is traveling.

However, the conventional device suggests to stop at a facility located on the planned route of the vehicle etc. based on how congested this facility is, but does not suggest to stop off at a facility located on the planned route of the vehicle etc. based on how congested the destination is.

If the destination is congested, for example, restrooms and eating and drinking facilities are also congested, an occupant may not be able to get enough rest, or it may take longer than expected to get a rest. In such a case, it is desirable for the occupant to take a break in advance at a facility before the destination rather than at the crowded destination.

For example, consider a case where a vehicle is heading to its destination, a commercial facility. If the destination commercial facility is crowded and there is a waiting time when using facilities such as toilets, the extra time it takes for the occupant to actually take a break after arriving at the destination. In this case, there is a need for the occupant to take a break in advance at a rest facility such as a parking area, which is located at a location where they can stop off before arriving at the destination commercial facility. Therefore, it is desirable that a device that provides information to an occupant should guide the facility on the scheduled route of the vehicle before arriving at the destination, in consideration of how congested the destination is.

The information processing device of the present disclosure solves such problems.

An information processing device according to an aspect of the present disclosure is an information processing device that provides information to occupants of a traveling vehicle, and is information relating to a destination congestion degree indicating a degree of congestion at a destination of the vehicle. Acquisition of congestion information and whether to output information on a first rest facility present between the traveling location of the vehicle and the destination based on the destination congestion information and a control unit that performs:

The destination congestion degree is a value indicating the degree of congestion of the destination to which an occupant of the vehicle is heading. The destination congestion degree may be, for example, the empty rate of a parking lot at the destination or the utilization rate of facilities such as toilets. Here, the vacancy rate of a parking lot is the ratio of spaces in which no vehicle is parked among the available parking spaces in the parking lot. The utilization rate of facilities is the ratio of facilities occupied by users among available facilities (for example, private toilets, seats in rest spaces, etc.).

These data may be provided by an external vendor and acquired by the information processing device.

The control unit switches whether to output information regarding a first rest facility, which is a rest facility present between the traveling location of the vehicle and the destination, according to the destination congestion degree. That is, the control unit may switch whether to suggest the occupant to stop off at the first rest facility according to the destination congestion degree.

Note that the traveling location refers to the location where the vehicle is currently traveling.

According to such a configuration, the information processing device can suggest the occupant to stop off at a facility located on the planned route of the vehicle, etc., while the vehicle is traveling, according to how congested the destination is.

In addition, the control unit calculates the travel time, which is the time required to travel from the second rest facility, which is the rest facility most recently used by the occupant, to the destination. When the destination congestion degree is equal to or higher than the first threshold and the travel time is equal to or longer than a predetermined time, the control unit may output information suggesting to stop off at the first rest facility. As a result, for example, in suggesting to stop off at a facility on the planned route of the vehicle, it can be expected to reduce the possibility of the occupant taking too long before taking a break after the last break. In addition, when the occupant continues driving for a long time, the occupant can be guided to take a break at a more appropriate timing.

Further, the control unit may acquire a road congestion degree, which is a degree of congestion of the road from the traveling location of the vehicle to the destination, and may calculate the travel time based partially on the road congestion degree.

For example, when suggesting to stop off at a facility on a planned route of a vehicle, the information processing device may take into account not only the distance to the destination but also the congestion degree of the road in calculating the travel time. As a result, it can be expected that a travel time that is close to the actual required time can be calculated.

Further, when a first congestion degree indicating a degree of congestion of the first rest facility is equal to or greater than a second threshold value, the control unit controls the first rest facility present between the traveling location of the vehicle and the destination. A rest facility different from the rest facility in the above may be searched for, and information regarding the retrieved rest facility may be output.

For example, the information processing device may avoid congested rest facilities and guide to less congested rest facilities. This can be expected to encourage the occupant to smoothly take a break.

Further, when the destination is a facility, the control unit may determine whether to output the information regarding the first rest facility based further on the category information indicating the category of the facility.

For example, the information processing device may avoid rest facilities whose category is the same as that of the destination when making a suggestion. This can be expected to prompt the occupant to take a rest at an appropriate facility.

Hereinafter, embodiments of the present disclosure will be described with reference to the drawings. A hardware configuration, a module configuration, a functional configuration, etc., described in each embodiment are not intended to limit the technical scope of the disclosure to them only unless otherwise stated.

### First Embodiment

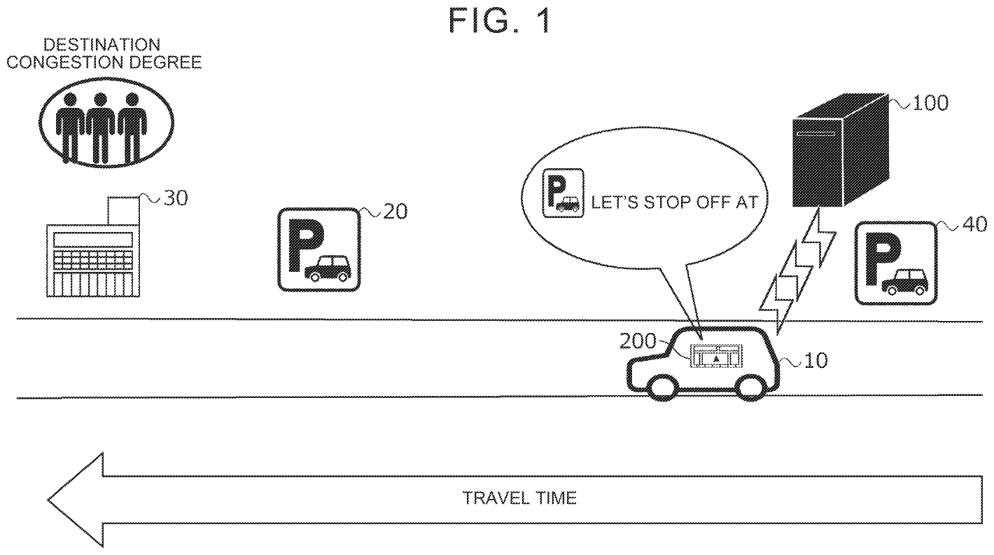

An overview of the information processing device according to the first embodiment will be described with reference to FIG. 1. FIG. 1 is a diagram for explaining the concept of services provided by the information processing device according to the first to third embodiments. The information processing device 100 according to the present embodiment provides information to the occupants via the in-vehicle terminal 200 mounted on the vehicle 10. The information processing device 100 may be installed outside the vehicle 10 and wirelessly connected to the in-vehicle terminal 200, or may be mounted in the vehicle 10 and connected to the in-vehicle terminal 200 by wire.

In this example, it is assumed that the vehicle 10 is traveling on the road toward the destination 30.

The following two types of methods can be exemplified as methods for the information processing device 100 to suggest to stop off at the rest facility. A first method is a method for providing information on the first rest facility 20 that is a rest facility located between the traveling location of the vehicle 10 and the destination 30, based on the destination congestion information that is information on the destination congestion degree indicating the degree of congestion of the destination 30. Specifically, the information processing device 100 outputs, via the in-vehicle terminal 200, information suggesting to stop off at the first rest facility 20 when the destination congestion degree is greater than or equal to the first threshold. That is, the information processing device 100 determines to output information suggesting to stop off at the first rest facility 20 located before the destination 30 when the destination 30 is crowded.

A second method is a method for providing information on the first rest facility 20, when the travel time, which is the time required to travel from the second rest facility 40, which is the rest facility most recently used by the occupant, to the destination 30 is calculated, and the destination congestion degree is equal to or more than the first threshold, and the travel time is equal to or longer than the predetermined time. In other words, the information processing device 100 does not allow the occupant to stop off at the first rest facility 20 before the destination 30 when the destination 30 is crowded and it will take some time before the occupant can take a rest next time. Decide to output the suggested information.

In this embodiment, the information processing device 100 provides information by the second method described above. However, the information processing device 100 can also provide information by the first method described above.

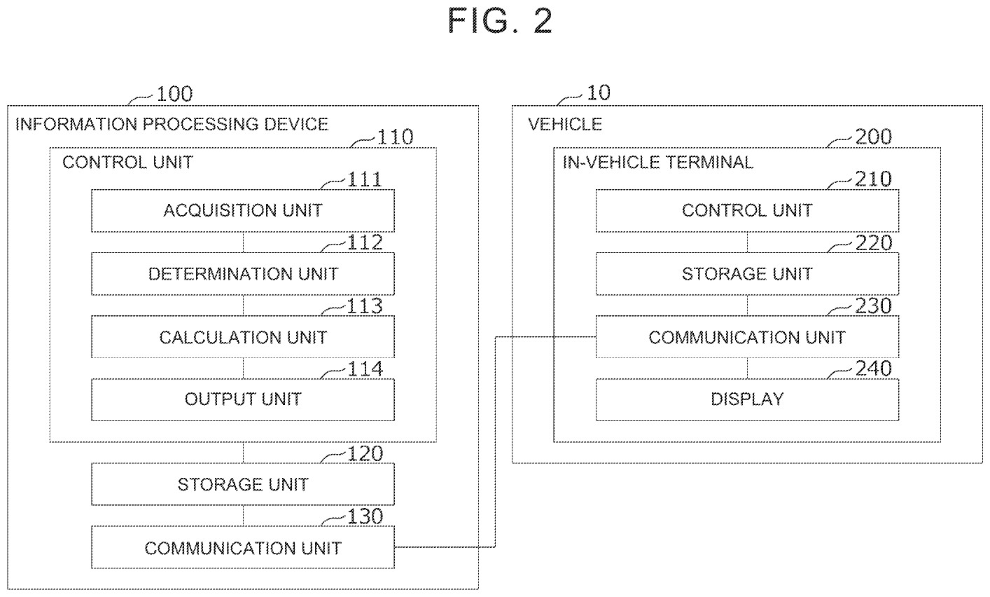

Next, each element constituting the system will be described in detail. FIG. 2 is a diagram illustrating components of the information processing device 100 according to the first embodiment.

The information processing device 100 according to the present embodiment includes a control unit 110, a storage unit 120, and a communication unit 130. The information processing device 100 performs wireless communication with an in-vehicle terminal 200 mounted in the vehicle 10 and outputs information via the in-vehicle terminal 200.

The control unit 110 is realized by a processor such as a Central Processing Unit (CPU) or a Graphics Processing Unit (GPU) and a memory. The control unit 110 includes an acquisition unit 111, a determination unit 112, a calculation unit 113, and an output unit 114 as functional modules. These functional modules may be realized by executing a program by control unit 110.

The acquisition unit 111 acquires destination congestion information, which is information about the destination congestion degree indicating the degree of congestion of the destination 30 of the vehicle 10. As described above, the destination congestion degree is a value indicating the degree of congestion of the destination 30 to which the occupants of the vehicle 10 are heading. For example, the vacancy rate of the parking lot at the destination 30 or the utilization rate of restrooms, dining spaces, and the like may be used. The acquisition unit 111 may acquire data representing the destination congestion degree from an external vendor.

Based on the destination congestion information and the travel time, the determination unit 112 determines whether to output information about the first rest facility 20, which is a rest facility present between the traveling location of the vehicle 10 and the destination 30.

In this embodiment, the travel time is the time required for the occupant to travel from the rest facility most recently used by the occupant to the destination 30. The travel time can be obtained from the calculation unit 113, which will be described later.
Specifically, when the destination congestion degree is equal to or greater than the first threshold and the travel time is equal to or greater than a predetermined time, the determination unit 112 determines to output information suggesting to stop off at the first rest facility 20 to the in-vehicle terminal 200.

The calculation unit 113 calculates the above-described travel time, that is, the time required to travel from the second rest facility 40, which is the rest facility most recently used by the occupant, to the destination 30. The calculation unit 113 may calculate the travel time based on the distance from the second rest facility 40 to the destination 30. Alternatively, the calculation unit 113 may calculate the travel time as the length of time from the departure time from the rest facility where the user took a rest immediately before to the scheduled arrival time at the destination 30. Calculation unit 113 transmits the calculated travel time to determination unit 112.

Further, when calculating the travel time, the calculation unit 113 also performs a process of identifying the second rest facility 40, which is the facility where the occupant most recently took a break, from among the plurality of rest facilities. Specifically, the calculation unit 113 calculates the second rest facility 40 based on the information regarding the plurality of rest facilities acquired by the acquisition unit 111, the travel data of the vehicle 10, the route information, and the like. Identify which rest facility among them.

It should be noted that the second rest facility 40 does not necessarily have to be a facility intended for rest as long as driving can be stopped. Further, when the occupant does not take a rest in the middle of the route, the calculation unit 113 may treat the starting point of the vehicle 10 as the second rest facility 40.

The output unit 114 transmits to the in-vehicle terminal 200 an instruction to output information suggesting to stop off at the first rest facility 20. More specifically, the output unit 114 outputs information suggesting to stop off at the first rest facility 20 when the determination unit 112 determines to output information about the first rest facility 20. Specifically, the output unit 114 may cause the in-vehicle terminal 200 to output information suggesting to stop off at the first rest facility 20.

The storage unit 120 is a main storage device such as RAM or ROM, an EPROM, a hard disk drive, and an auxiliary storage device such as removable media. The auxiliary storage device stores an operating system (OS), various programs, various tables, etc. By executing the programs stored therein, each part of the control unit 110 realizes each function that meets the predetermined purpose. However, some or all of the functions may be implemented by a hardware circuit such as an ASIC or an FPGA.

The storage unit 120 stores data used or generated in the process performed by the control unit 110. The storage unit 120 may store map data acquired by the acquisition unit 111 from an external device, or data such as the destination congestion degree.

The communication unit 130 is configured by a communication circuit that performs wireless communication. The communication unit 130 may be, for example, a communication circuit that performs wireless communication using the 4th Generation (4G), or a communication circuit that performs wireless communication using the 5th Generation (5G). Further, the communication unit 130 may be a communication circuit that performs wireless communication using Long Term Evolution (LTE), or may be a communication circuit that performs communication using Low Power Wide Area (LPWA). Also, the communication unit 130 may be a communication circuit that performs wireless communication using Wi-Fi (registered trademark). Further, the communication unit 130 may include a wired communication circuit, and may communicate with the in-vehicle terminal 200 or the like connected to the communication unit 130 by wire, for example.

Next, devices other than the information processing device 100 will be described.

The in-vehicle terminal 200 is typically a terminal such as a car navigation system that provides information to an occupant of the vehicle 10. The in-vehicle terminal 200 may be realized by a smart phone or a tablet terminal. A control unit 210 included in the in-vehicle terminal 200 is realized by a CPU or a processor such as a GPU and a memory. And the control unit 210 implements the following functions. These functional modules may be realized by executing a program by control unit 210.

When control unit 210 receives an instruction from information processing device 100 to output information suggesting to stop off at the first rest facility 20, control unit 210 outputs a screen showing the information on display 240. Further, the control unit 210 may cause the audio output unit to output audio indicating the content of the information received from the information processing device 100. Further, the control unit 210 periodically transmits probe information (position information of the vehicle 10, speed of the vehicle 10, etc.) to the information processing device 100.

The storage unit 220 is a main storage device such as RAM or ROM, an EPROM, a hard disk drive, and an auxiliary storage device such as removable media. The auxiliary storage device stores an operating system (OS), various programs, various tables, etc. By executing the programs stored therein, each part of the control unit 110 realizes each function that meets the predetermined purpose. However, some or all of the functions may be implemented by a hardware circuit such as an ASIC or an FPGA.

The storage unit 220 stores data and the like used or generated in the processing performed by the control unit 210.

The communication unit 230 is configured by a communication circuit that performs wireless communication. The communication unit 230 may be, for example, a communication circuit that performs wireless communication using 4G, or a communication circuit that performs wireless communication using 5G. Also, the communication unit 130 may be a communication circuit that performs wireless communication using LTE, or may be a communication circuit that performs communication using LPWA. Also, the communication unit 230 may be a communication circuit that performs wireless communication using Wi-Fi (registered trademark). The communication unit 230 may also include a wired communication circuit, and may communicate with the information processing device 100 or the like connected to the communication unit 230 by wire, for example.

Display 240 is a display device that outputs information received from information processing device 100. Specifically, display 240 receives an instruction from control unit 210 of in-vehicle terminal 200 and outputs information received from information processing device 100. The display 240 may be a touch panel display, an organic Electro Luminescence (EL) display, or a liquid crystal display.

The configuration shown in FIG. 2 is an example, and all or a part of the functions shown in FIG. 2 may be executed using a specially designed circuit. Further, a program may be stored or executed by a combination of the main storage device and the auxiliary storage device other than the functions shown in FIG. 2.

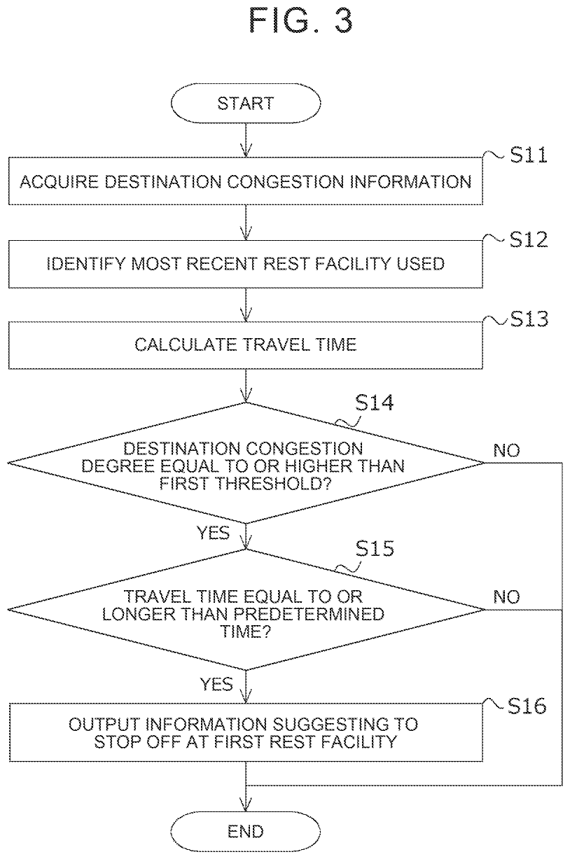

Next, specific contents of processing performed by the information processing device 100 will be described. FIG. 3 is a flowchart of processing executed by the control unit 110 of the information processing device 100 according to the first embodiment. The illustrated process is repeatedly executed while the vehicle 10 is running. It is assumed that the vehicle 10 is traveling toward the destination 30 before S11 is started. Running toward the destination 30 includes a state in which the vehicle is running to the destination 30 and is temporarily stopped at a traffic light or the like.

First, in S11, the acquisition unit 111 acquires destination congestion information. Destination congestion information is information about the destination congestion degree. As described above, the destination congestion degree is a value indicating the degree of congestion of the destination 30 to which the vehicle 10 is heading. For example, the acquisition unit 111 may access an external server or the like and acquire the provided destination congestion information.

Next, in S12, the calculation unit 113 identifies the second rest facility 40, which is the facility where the user most recently took a rest. The calculation unit 113 may determine the second rest facility 40 based on the travel history of the vehicle 10 and information regarding a plurality of rest facilities. Information about a plurality of rest facilities may be stored in the storage unit 120, or may be provided by an external server.

Next, in S13, the calculation unit 113 calculates the travel time, which is the time required to travel from the second rest facility 40, which is the rest facility most recently used by the occupants of the vehicle 10, to the destination 30. The calculation unit 113 calculates the second location based on map data stored in advance, location information of individual rest facilities, or location information of the second rest facility 40 and the destination 30 acquired from an external server or the like. A distance from the rest facility 40 to the destination 30 is calculated. Then, the calculation unit 113 may calculate the travel time based on the calculated distance.

Next, in S14, the determination unit 112 determines whether the destination congestion degree is greater than or equal to the first threshold. When the determination unit 112 determines that the destination congestion degree is equal to or greater than the first threshold, the determination result in this step is Yes.

When Yes in S14, the process transitions to S15.

When No in S14, the process ends.

When the process transitions to S15, the determination unit 112 determines that the travel time, which is the time required to travel from the second rest facility 40, which is the rest facility most recently used by the occupant of the vehicle 10, to the destination 30 is It is determined whether the time is longer than or equal to a predetermined time. When the determination unit 112 determines that the travel time is equal to or longer than the predetermined time, the determination result in this step is Yes.

When Yes in S15, the process transitions to S16.

When No in S15, the process ends.

When the process transitions to S16, the determination unit 112 determines that information regarding the first rest facility 20, which is a rest facility present between the traveling location (that is, the current position) of the vehicle 10 and the destination 30, is to be output. Specifically, the determination unit 112 determines that the first rest facility 20 is specified, and that information suggesting to stop off at the rest facility is to be output. Then, the output unit 114 transmits an instruction to the in-vehicle terminal 200 to output information suggesting to stop off at to the first rest facility 20.

The control unit 210 of the in-vehicle terminal 200 that receives an instruction from the output unit 114 to output information suggesting a stop-by at the first rest facility 20 prompts the display 240 to output the information for suggesting to stop off at the first rest facility 20. That is, the display 240 displays information suggesting to stop off at the first rest facility 20.

Although FIG. 3 shows an example in which the determination unit 112 determines both the destination congestion degree and the travel time, the determination unit 112 only determines the destination congestion degree and may not determine the travel time. Specifically, the determination unit 112 may determine to output information about the first rest facility 20 when it determines that the destination congestion degree is equal to or greater than the first threshold. In other words, the determination unit 112 may determine to output information suggesting to stop off at the first rest facility 20 when determining that the destination congestion degree is equal to or greater than the first threshold. Then, the output unit 114 may transmit to the in-vehicle terminal 200 an instruction to output information suggesting to stop off at the first rest facility 20. In this case, the processing of S13 and S15 may be omitted.

### Second Embodiment

In the first embodiment, the information processing device 100 determines whether to output information on the first rest facility 20 based on the destination congestion degree indicating the degree of congestion of the destination 30 and the travel time from the second rest facility 40 to the destination 30. Specifically, the information processing device 100 outputs information for suggesting to stop off at the first rest facility 20 when the destination congestion degree is equal to or greater than a first threshold and the travel time is equal to or greater than a predetermined time.

One of the purposes of the present disclosure is to allow the occupants of the vehicle 10 to take breaks at appropriate times so that it does not take too long before the occupants of the vehicle 10 can take a break. Therefore, in order to provide more accurate guidance, it is preferable to calculate the travel time by taking into consideration how congest the road actually is.

In order to deal with this, the second embodiment is an embodiment in which the information processing device 100 calculates the travel time based on how congested the road is.

In the second embodiment, the calculation unit 113 calculates the travel time, which is the time required to travel from the second rest facility 40, which is the rest facility most recently used by the occupant of the vehicle 10, to the destination 30, by using the road congestion degree that is the degree of congestion of the road from the traveling location of the vehicle 10 to the destination 30. For example, the calculation unit 113 may calculate a longer travel time as the road congestion degree is higher, that is, as the road is more congested.

Here, the road congestion degree is a value indicating the degree of congestion of the road from the traveling location of the vehicle 10 to the destination 30. For example, the road congestion degree may be an index calculated based on the number of vehicles traveling per distance, or may be an index calculated based on the speed per hour at which the vehicle 10 can travel on the road from the traveling location to the destination 30. The road congestion degree may be a value that becomes higher as the traffic volume passing through the target road increases.

By the calculation unit 113 performing the above operation, the calculation unit 113 can calculate a travel time that is closer to the actual travel time. Then, the information processing device 100 can guide the occupant to rest facilities in a more realistic manner.

In this embodiment, the acquisition unit 111 is configured to be able to further acquire the road congestion degree. The acquisition unit 111 accesses an external server or the like and acquires the provided road congestion degree.

In the first embodiment, the destination congestion degree and travel time are used to determine whether to output information about the first rest facility 20. In the second embodiment, the destination congestion degree and the travel time are used to determine whether to output information about the first rest facility 20. A road congestion degree, which is the congestion degree of the road from the traveling location of the vehicle 10 to the destination 30, is further used to calculate the travel time.

In the second embodiment, the following processes are executed in S13 in the first embodiment (FIG. 3). Processing in other steps is the same as in the first embodiment.

First, the acquisition unit 111 acquires the road congestion degree. The acquisition unit 111 accesses an external server or the like and acquires provided information about the road congestion degree.

Next, the calculation unit 113 calculates the travel time, which is the time required to travel from the second rest facility 40, which is the rest facility most recently used by the occupant of the vehicle 10, to the destination 30 using the road congestion degree. For example, the calculation unit 113 may calculate travel time using the road congestion degree in addition to the distance to the destination 30 used in the first embodiment. For example, the calculation unit 113 may calculate an average speed based on the road congestion degree, and calculate travel time based on the calculated average speed and distance.

### Third Embodiment

In the first embodiment, the information processing device 100 determines whether to output information on the first rest facility 20 based on the destination congestion degree indicating the degree of congestion of the destination 30 and the travel time from the second rest facility 40 to the destination 30. Specifically, the information processing device 100 suggest to stop off at the first rest facility 20 when the destination congestion degree is equal to or greater than a first threshold and the travel time is equal to or greater than a predetermined time.

However, if the suggested first rest facility 20 is congested, even if the occupant stops off at the suggested first rest facility 20, the occupant may not be able to get a sufficient rest, or may not be able to take a break within a predetermined period of time. Therefore, the information processing device 100 preferably considers not only the congestion degree of the destination 30 but also the congestion degree of the first rest facility 20 and guides the user to drop in at an appropriate rest facility.

In the third embodiment, in order to deal with this, the information processing device 100 selectively suggests to stop off at the first rest facility 20 or to stop off at a different facility, based on how congested the first rest facility 20 is.

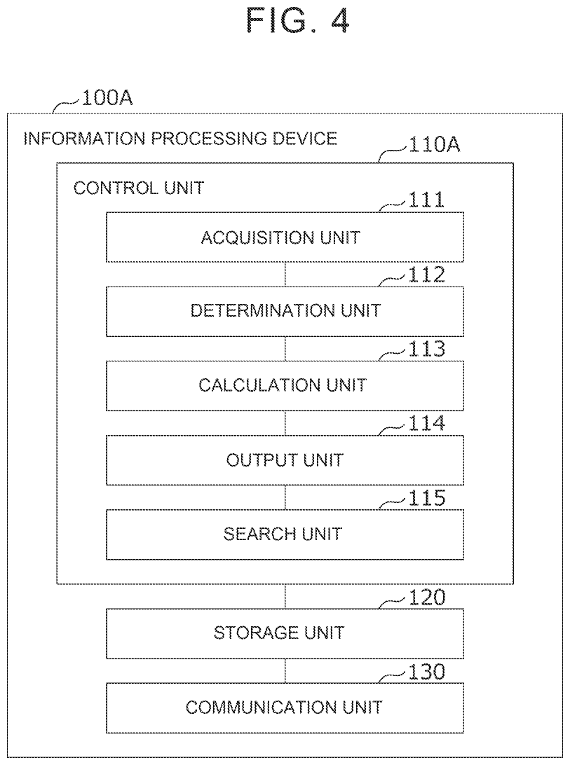

FIG. 4 is a diagram illustrating components of an information processing device 100A according to the third embodiment. The control unit 110A of the information processing device 100A of the third embodiment includes a search unit 115 in addition to the components included in the information processing device 100 in the first and second embodiments.

The search unit 115 searches for a rest facility different from the first rest facility 20 that is present between the traveling location of the vehicle 10 and the destination 30 when the first congestion degree indicating the degree of congestion of the first rest facility 20 is equal to or greater than the second threshold. Specifically, the search unit 115 selects an appropriate rest facility from the information on a plurality of rest facilities stored in advance in the storage unit 120 based on the traveling location of the vehicle 10 and the position information of the destination 30. may For example, the search unit 115 may select another rest facility closest to the first rest facility 20 when the first congestion degree corresponding to the first rest facility 20 is greater than or equal to the second threshold.

Also, in the third embodiment, the determination unit 112 determines whether the first congestion degree corresponding to the first rest facility 20 is equal to or greater than the second threshold. That is, the determination unit 112 determines whether the first rest facility 20 is more crowded than a predetermined state.

Further, in the third embodiment, the acquisition unit 111 accesses an external server or the like and acquires provided information about the first congestion degree.

In the first embodiment, the first rest facility 20 is the only rest facility suggested as a stop-off. On the other hand, in the third embodiment, based on the first congestion degree indicating the degree of congestion of the first rest facility 20, information suggesting to stop off at the first rest facility 20 is output, or other rest facility is output. It is possible to switch whether to output information suggesting to stop off at a facility.

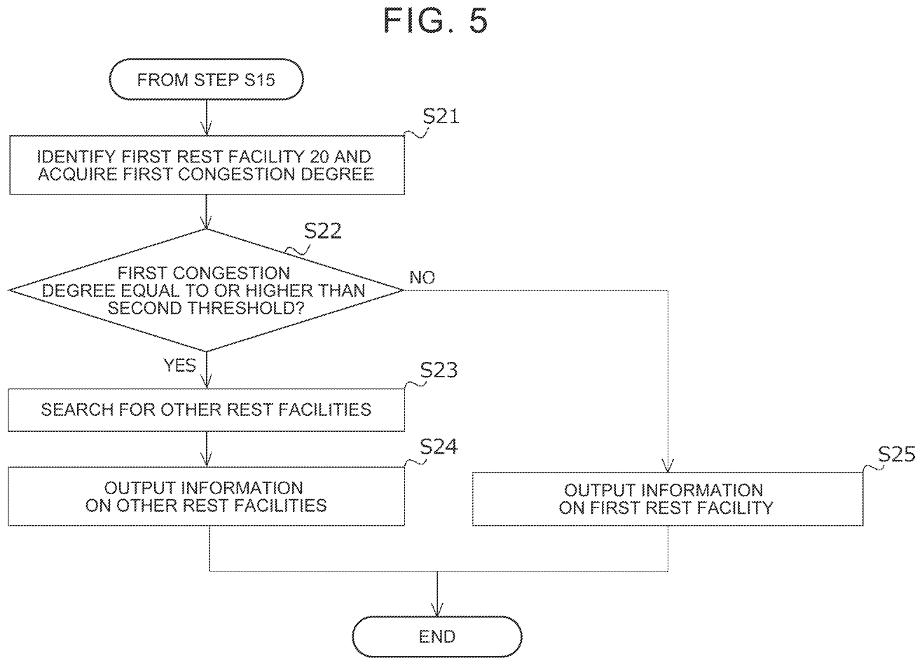

FIG. 5 is a flowchart of processing executed by the control unit 110A of the information processing device 100A according to the third embodiment. The processing of this flowchart is executed subsequent to S15 of the first embodiment (FIG. 3).

In S21, the acquisition unit 111 identifies the first rest facility 20 and acquires the first congestion degree indicating the degree of congestion of the first rest facility 20. The first congestion degree may be, for example, the vacancy rate of the parking lot of the first rest facility 20 or the utilization rate of rest facilities such as restrooms. The acquisition unit 111 accesses an external server or the like and acquires the provided first congestion degree.

In S22, the determination unit 112 determines whether the first congestion degree corresponding to the first rest facility 20 is greater than or equal to the second threshold. When the determining unit 112 determines that the first congestion degree is equal to or greater than the second threshold, the determination result in this step is Yes.

When Yes in S22, the process proceeds to S23.

When No in S22, the process proceeds to S25.

When the process proceeds to S23, the search unit 115 searches for rest facilities other than the first rest facility 20 that are located between the traveling location of the vehicle 10 and the destination 30. At this time, the search unit 115 selects, as other rest facilities, rest facilities where the occupant of the vehicle 10 can take a rest at an appropriate timing, taking into consideration the location information and congestion degrees of other rest facilities.

Next, in S24, the determination unit 112 determines to output information about other rest facilities found. That is, determination unit 112 determines to cause output unit 114 to transmit to in-vehicle terminal 200 an instruction to output information suggesting to stop off at another rest facility. At this time, the determination unit 112 does not determine to cause the output unit 114 to output the information suggesting to stop off at the first rest facility 20 to the in-vehicle terminal 200.

The control unit 210 of the in-vehicle terminal 200 that receives the instruction to output the information suggesting to stop off at another rest facility from the output unit 114 causes the display 240 to output the information suggesting to stop off at another rest facility. In other words, the display 240 displays information suggesting to stop off at another rest facility.

When the process has transitioned to S25, the determination unit 112 determines to output information regarding the first rest facility 20. In other words, the determination unit 112 determines to cause the output unit 114 to transmit to the in-vehicle terminal 200 an instruction to output information suggesting to stop off at the first rest facility 20.

The control unit 210 of the in-vehicle terminal 200 receives an instruction from the output unit 114 to output information suggesting to stop off at the first rest facility 20, and displays the information suggesting to stop off at the first rest facility 20 on the display 240. That is, the display 240 displays information suggesting to stop off at the first rest facility 20.

### Modified Example of the Third Embodiment

In the third embodiment, whether to suggest to stop off at the first rest facility 20 or at another facility is determined according to the first congestion degree indicating the degree of congestion at the first rest facility 20. On the other hand, in the modified example of the third embodiment, whether to suggest to stop off at the first rest facility 20 or to suggest to stop off at a different facility is determined according to the information indicating the category of the first rest facility 20 instead of the first congestion degree.

In this modified example, the acquisition unit 111 is configured to be able to acquire category information indicating the category of the first rest facility 20. The category of the first rest facility 20 may be information indicating the category (classification) of use of the first rest facility 20, such as commercial facilities and parking areas. The acquisition unit 111 may access an external server or the like to acquire provided category information.

The determination unit 112 determines whether to output information about the first rest facility 20 based on the category of the first rest facility 20 acquired by the acquisition unit 111. For example, the determination unit 112 may determine to output information about the first rest facility 20 when it determines that the category of the first rest facility 20 belongs to a predetermined category.

Here, when the destination 30 is a facility, for example, the predetermined category can be a category different from the category to which the facility belongs. In this case, it is possible to prevent a facility belonging to the same category as the destination 30 from being suggested as a rest facility. Alternatively, the predetermined category may be small commercial facilities such as convenience stores or supermarkets. In this case, it is possible to suggest as a rest facility a facility in which rest can be smoothly taken without waiting time.

Note that the predetermined category may be other than this. For example, the predetermined category may be determined based on the preferences of the occupants of the vehicle 10.

When the determination unit 112 determines that the category of the first rest facility 20 is the predetermined category, the determination unit 112 may determine to cause the output unit 114 to transmit an instruction for causing the in-vehicle terminal 200 to output information for suggesting to stop off at the first rest facility 20. Further, when the determination unit 112 determines that the category of the first rest facility 20 is not the predetermined category, the determination unit 112 may not determine to cause the output unit 114 to transmit an instruction for causing the in-vehicle terminal 200 to output information for suggesting to stop off at the first rest facility 20.

When the category of the first rest facility 20 is not the predetermined category, the search unit 115 searches for other rest facilities different from the first rest facility 20 that is present between the traveling location of the vehicle 10 and the destination 30.

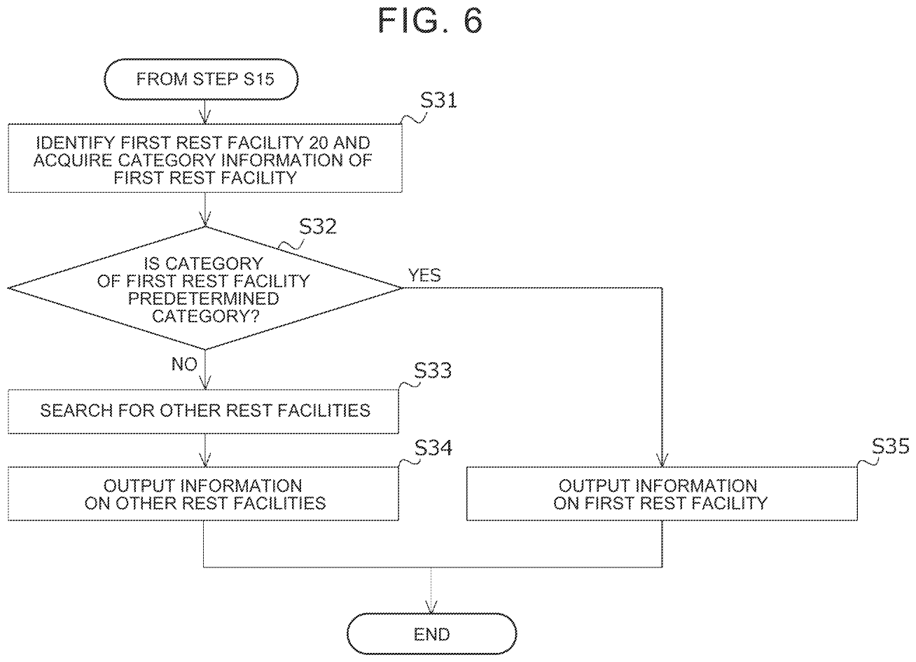

FIG. 6 is a flowchart of processing executed by the control unit 110A of the information processing device 100A according to the modification of the third embodiment. The processing of this flowchart is executed subsequent to S15 of the first embodiment (FIG. 3).

In S31, the acquisition unit 111 identifies the first rest facility 20 and acquires category information indicating the category of the first rest facility 20. The category information may be, for example, information indicating the usage of the first rest facility 20 such as a commercial facility or a parking area. The acquisition unit 111 accesses an external server or the like and acquires provided category information.

In S32, the determination unit 112 determines whether the category of the first rest facility 20 is a predetermined category. When the determination unit 112 determines that the category of the first rest facility 20 is the predetermined category, the determination result in this step is Yes.

When Yes in S32, the process proceeds to S35.

When No in S32, the process proceeds to S33.

When the process transitions to S33, the search unit 115 searches for rest facilities other than the first rest facility 20 that is present between the traveling location of the vehicle 10 and the destination 30. At this time, the search unit 115 selects, as other rest facilities, a rest facility where the occupant can take a rest at an appropriate timing, taking into consideration the position information and congestion degree of other rest facilities.

Next, in S34, the determination unit 112 determines to output information about other rest facilities found. That is, the determination unit 112 determines to cause the output unit 114 to transmit an instruction to output information suggesting to stop off at another rest facility. At this time, the determination unit 112 does not determine that the output unit 114 should transmit an instruction to output information suggesting to stop off at the first rest facility 20.

The control unit 210 of the in-vehicle terminal 200 that receives the instruction to output the information suggesting to stop off at another rest facility from the output unit 114 causes the display 240 to output the information suggesting to stop off at another rest facility. In other words, the display 240 displays information suggesting to stop off at another rest facility.

When the process has transitioned to S35, the determination unit 112 determines to output information regarding the first rest facility 20. In other words, the determination unit 112 determines to cause the output unit 114 to transmit to the in-vehicle terminal 200 an instruction to output information suggesting to stop off at the first rest facility 20.

The control unit 210 of the in-vehicle terminal 200 receives an instruction from the output unit 114 to output information suggesting to stop off at the first rest facility 20, and displays the information suggesting to stop off at the first rest facility 20 on the display 240. That is, the display 240 displays information suggesting to stop off at the first rest facility 20.

### Modified Examples

The above-described embodiments are merely examples, and the present disclosure may be appropriately modified and implemented without departing from the scope thereof.

For example, the processes and means described in the present disclosure can be freely combined and implemented as long as no technical contradiction occurs.

Further, the processes described as being executed by one device may be shared and executed by a plurality of devices. Alternatively, the processes described as being executed by different devices may be executed by one device. In the computer system, it is possible to flexibly change the hardware configuration (server configuration) for realizing each function.

The present disclosure can also be implemented by supplying a computer with a computer program that implements the functions described in the above embodiment, and causing one or more processors of the computer to read and execute the program. Such a computer program may be provided to the computer by a non-transitory computer-readable storage medium connectable to the system bus of the computer, or may be provided to the computer via a network. The non-transitory computer-readable storage medium is, for example, a disc of any type such as a magnetic disc (floppy (registered trademark) disc, hard disk drive (HDD), etc.), an optical disc (compact disc read-only memory (CD-ROM), digital versatile disc (DVD), Blu-ray disc, etc.), a read only memory (ROM), a random access memory (RAM), an erasable programmable read only memory (EPROM), an electrically erasable programmable read only memory (EEPROM), a magnetic card, a flash memory, an optical card, and any type of medium suitable for storing electronic commands.

What is claimed is:

1. An information processing device configured to provide information to an occupant of a vehicle that is traveling, the information processing device comprising a control unit configured to
acquire destination congestion information, the destination congestion information being information on a destination congestion degree indicating a degree of congestion of a destination of the vehicle, and
determine whether to output information on a first rest facility based on the destination congestion information, the first rest facility being a rest facility that is present between a traveling location of the vehicle and the destination.

2. The information processing device according to claim 1, wherein the control unit is configured to
calculate a travel time, the travel time being a time required to travel from a second rest facility to the destination, the second rest facility being a rest facility most recently used by the occupant, and
when the destination congestion degree is equal to or higher than a first threshold and the travel time is equal to or longer than a predetermined time, output information suggesting to stop off at the first rest facility.

3. The information processing device according to claim 2, wherein the control unit is configured to
acquire a road congestion degree, the road congestion degree being a degree of congestion of a road from the traveling location of the vehicle to the destination, and
calculate the travel time based partially on the road congestion degree.

4. The information processing device according to claim 2, wherein the control unit is configured to
when a first congestion degree indicating a degree of congestion of the first rest facility is equal to or higher than a second threshold, search for another rest facility different from the first rest facility, the other rest facility being a rest facility located between the traveling location of the vehicle and the destination, and
output information on the other rest facility found as a result of the search.

5. The information processing device according to claim 1, wherein the control unit is configured to, when the destination is a facility, determine whether to output the information on the first rest facility based further on category information indicating a category of the facility.

6. An information processing method that is performed by an information processing device configured to provide information to an occupant of a vehicle that is traveling, the information processing method comprising:
acquiring destination congestion information, the destination congestion information being information on a destination congestion degree indicating a degree of congestion of a destination of the vehicle; and
determining whether to output information on a first rest facility based on the destination congestion information, the first rest facility being a rest facility that is present between a traveling location of the vehicle and the destination.
